(19) United States
(12) Patent Application Publication
(10) Pub. No.: US 2005/0120891 A1
(43) Pub. Date: Jun. 9, 2005

(54) Rectangular cake pan assembly

(76) Inventor: Fletcher Morgan, St. Petersburg, FL (US)

Correspondence Address: JOHN S. HALE;GIPPLE & HALE, 6665-A OLD DOMINION DRIVE, MCLEAN, VA, 22101, US

(21) Appl. No.: 11/039,898

(22) Filed: Jan. 24, 2005

Related U.S. Application Data
(63) Continuation-in-part of application No. 11/006,741, filed on Dec. 8, 2004.
Application No. 11/006,741 is a continuation-in-part of application No. 29/195,320, filed on Dec. 10, 2003.
Application No. 29/195,320 is a continuation-in-part of application No. 29/178,855, filed on Apr. 2, 2003, now Pat. No. D487667.
Application No. 29/195,320 is a continuation-in-part of application No. 10/609,653, filed on Jul. 1, 2003.
Application No. 10/609,653 is a continuation-in-part of application No. 10/424,764, filed on Apr. 29, 2003, now Pat. No. 6,789,466.
Application No. 10/424,764 is a continuation-in-part of application No. 10/302,903, filed on Nov. 25, 2002, now Pat. No. 6,840,162.

(51) Int. Cl. A23P 1/00

(52) U.S. Cl. 99/426

(57) ABSTRACT

A dessert pan assembly for forming a compound dessert constructed with a rectangularly configured rectangular base pan having side walls and a bottom defining a cavity. A planar flange extends outward from the sidewalls of the rectangular cake pan to support a cover member which is mounted to the rectangular cake pan and defines two opposing handles. The cover member has a plurality of smooth surfaced oblong projections defining spaced open ended cavities and a planar skirt defining opposing handles which sit on the rectangular cake pan flange. The cover member is held in place by slideable lock member which is slidably mounted on the surface of the skirt to slide over the handles of the base pan and be removed from the handles of the base pan. The planar skirt extends over the rectangular base pan cavity and is provided with a plurality of holes overlying the rectangular cake pan cavity to allow gases to escape from the rectangular cake pan.

### CROSS-REFERENCE TO RELATED APPLICATIONS

This is a continuation-in-part application of U.S. patent application Ser. No. 11/006,741, filed Dec. 8, 2004 which is a continuation-in-part of U.S. Design patent application Ser. No. 29/195,320 filed Dec. 10, 2003 which is a continuation-in-part of U.S. Design patent application Ser. No. 29/178,855 filed Apr. 2, 2003 and U.S. patent application Ser. No. 10/609,653 filed Jul. 1, 2003 which is a continuation-in-part application of U.S. patent application Ser. No. 10/424,764 filed Apr. 29, 2003 which is a continuation-in-part application of U.S. patent application Ser. No. 10/302,903 filed Nov. 25, 2002.

### TECHNICAL FIELD OF THE INVENTION

The present invention relates generally to the field of cake baking and dessert molds. More particularly, the present invention concerns a base pan for baking a rectangular shaped cake or molded dessert having a plurality of spaced oblong cavities formed therein by a pan cover formed with a plurality of spaced protrusions which extend into a cavity formed by the base pan. Optimally, the dessert can have an outer decorative exterior formed by the fluted and embossed interior of the base pan.

The present invention is thus directed toward an apparatus for molding cake batter, ice creams, gelatins or other desserts into an outer fluted and embossed design rectangular shape with a plurality of separate smaller shaped spaced cavities having a generally oblong configuration.

### BACKGROUND OF THE INVENTION

Food molds have been used and are well known in the prior art. A common baking pan is a food mold, with an open end, a closed end and a peripheral side wall. The closed end and side wall define a hollow volume that becomes the three-dimensional shape of a food product molded by the baking pan.

Some food pans, such as a baking pan for making angel food cake, have an annular ring shaped with an open end. The hollow volume of the ring is filled with a food composition and then baked. After baking, the pan is inverted to remove the shaped food composition from the open end. Thus, the open end is used to form the bottom of the final cake product.

Other food molds have a centrally located indentation at the closed end. With a mold of this type, a first food composition may be placed and formed in the open end and a second food composition may be placed in the complementary shaped indentation at the closed end. This provides an accurate fit for the second filler food composition within the first supporting food composition.

In all baking pans, it is desirable to facilitate the partial escape of moisture from the pans in order to develop a degree of porosity in the final baked product. At the same time, however, the batter must absorb some moisture to prevent excessive dehydration. It therefore becomes necessary to contain the batter at a pressure sufficient to limit the extent to which water is converted to steam, since the batter absorbs steam less easily than water, while allowing for a degree of conversion and escape. The batter must also be contained to prevent the escape of the cake itself due to its expansion during baking.

It can thus be seen that a number of devices have been used in the molding and baking of desserts to obtain molded desserts in a variety of shaped configurations as described in the prior art. However covered dual composition desserts are rare because of the complexity in preparing same.

Historically, it was known in the prior art to bake bread bowls which were semi-spherical loaves of bread into which a cavity was carved for placement of salads or soups. A conventional bread bowl is typically made by forming raw bread dough in a simple inverted bowl which is then placed into the oven for baking. Bread bowls made in this manner often rise from the inverted bowl so that the same presents an uneven appearance, requiring trimming and waste.

Many prior art devices and techniques mold and bake dough of breads, batters of cakes, cookies, and other baked goods into various shapes including containers which may be used to hold other foods. For example, U.S. Pat. No. 4,812,323, issued Mar. 14, 1989, discloses a method for molding and baking cookie dough into a cup shape which can then be used to hold ice cream or other fillings in a similar manner to U.S. Pat. No. 3,296,956, issued Jan. 10, 1967, which also discloses a molding and baking apparatus for the baking of bread dough into a cup-like shape.

In U.S. Pat. No. 3,141,400 issued Jul. 21, 1964 a telescoping cake apparatus is disclosed with a center cone assembly which moves upward when the cake batter is baked forming a frustrum conical cake with a conical center cavity. A one piece strip cross link handle is secured to the upper edge of top of the expendable baking section and the cone by staples or the like.

U.S. Pat. No. 1,487,906 issued Mar. 25, 1924 is directed toward two nesting rectangular baking pans, the inner pan having flange members adapted to sit on a shelf formed in the outer pan with the composite unit being held in place by a strip of sheet metal which engages an upwardly extending flange of the outer pan.

A baked layered product with an apparatus for making same is shown in U.S. Pat. No. 3,831,507, issued Aug. 27, 1974. This baking assembly uses three baking pans to form a cylindrical bunt bowl body and lid which is placed over the body to hold the filling therein.

Similarly U.S. Pat. No. 1,852,966 issued Apr. 5, 1932 is directed toward a baking pan used for baking a cake with a hollow center so that the same can have a filling placed therein. A tapered tubular outer member has a core mold mounted thereon attached to a cover over the top of the tubular outer member.

The use of nested trays for forming shaped multiple individual baked goods is typified by the common muffin tray. Stacked or nesting trays for forming shaped baked goods such as bread are shown in U.S. Pat. No. 5,232,609 issued Aug. 3, 1993.

U.S. Pat. No. 5,948,313, issued Sep. 7, 1999 is directed toward a mold assembly for making a baked edible shell. The mold assembly is constructed of an outer mold shell and an associated inner mold shell, the outer mold shell having a curved main portion with a central opening and an outer rim extending in a plane. The inner mold shell has a curved main portion with a central chimney shaped to pass through the outer mold central opening. The outer mold opening comprises a raised circular rim with an inwardly directed flange. The outer edge of the outer mold shell is formed with a rolled-up rim. When the edible material is being cooked, a metal strip with curved ends is mounted over the rolled rim of the outer shell mold as seen in FIGS. 4 and 5C to hold both mold-shells in relative positions to eliminate expansion of the edible material during cooking.

Another reference, U.S. Pat. No. 5,226,352 issued Jul. 13, 1993 is directed toward a baking assembly which has an outer dome shaped member and an inner dome shaped member as shown in FIGS. 6 and 7. A flange extends outward from the upper edge of the outer dome member to seat the flange extending from the upper edge of the inner dome member. The flanges are held together by a C clamp or other fastening means. The inner dome shaped member is TEFLON® coated on its inside surface and outside surface allowing cake or dough to be baked in the outer dome mold and the inner mold.

Hemispherical shaped or dome cakes having dual composition are popular in Italian dessert cooking and are generally known as “Zuccotto”. These cakes are prepared by slicing previously baked sponge cake (Pan di Spagna) into thin, vertical slices, lining the interior of a bowl with plastic wrap and lining the plastic wrap in the bowl with overlapping pieces of the sponge cake slices. The slices of cake are then sprinkled with liquor and the dampened assembly is then covered with a plastic wrap and refrigerated. A center mixture of chocolate or other filling is poured into the cake lined bowl and the bottom or exposed surface of the filling is covered with other slices of cake. The entire cake is allowed to set for a number of hours, preferably overnight, inverted onto a platter and dusted with confectioners sugar. As can be seen, the process for making this cake is quite laborious in time and resources required.

It has been found desirable to mold or form desserts or cake into a rounded rectangular surfaced shape optionally having decorative outer surface which has a plurality of spaced cavities formed therein and which can be baked and/or frozen and marketed as a specialized cake having different components.

### SUMMARY OF THE INVENTION

The present invention is directed toward an assembly for producing a dual composition dessert or cake using a rounded corner rectangular baking pan having a cover member formed with a plurality of spaced oblong projections formed in a planar skirt extending into the pan cavity to form an oblong cavities in a cake baked in the rectangular baking pan. The cover member planar skirt extends away from the periphery of the oblong projections and the cover member is seated on a flange formed on the rectangular baking pan. A plurality of slideable locking members are slidably mounted on the planar surface of the skirt of the cover member to engage the outer periphery and lower surface of the flange of the rectangular baking pan holding the same together. The base pan can optionally be formed having fluted sides and an embossed design to provide a base cake with a decorative exterior for the cake or dessert formed in the pan.

It is an object of the invention to prepare two different composition food products formed as a single dessert.

It is still another object of the invention to provide a dessert assembly which delivers heat energy evenly to all areas of a cake being baked therein.

Yet another object of the invention is to provide a dessert assembly that is easy to use, ruggedized and reliable.

It is a further object of the invention to mold multiple food products made of cake batter or another dessert composition in a desired shape and bake or set the compositions to form a multiple composition dessert.

It is yet another object of the invention to provide a dessert assembly which is easily broken into individual components and is easy to clean.

Another object of the invention is to provide a dessert assembly for simultaneously baking multiple food products formed of cakes of different sizes with a plurality of smaller cakes fitting into cavities formed during the baking process in the outer base cake to produce a composition uniform cake that is predictable and reproducible without size variance.

Still another object of the invention is to provide a dessert assembly that has one or more of the characteristics discussed above but which is relatively simple to use and requires a minimum of cooking skills.

In the accompanying drawings, there is shown illustrative embodiments of the invention from which these and other objectives, novel features and advantages will be readily apparent.

These and other objects, advantages, and novel features of the present invention will become apparent when considered with the teachings contained in the detailed disclosure along with the accompanying drawings.

### BRIEF DESCRIPTION OF THE DRAWINGS

FIG. 1 is a perspective view of the rectangular cake pan assembly;

FIG. 2 is an exploded perspective view of the rectangular cake pan assembly of FIG. 1;

FIG. 3 is an exploded perspective view of another embodiment of the rectangular cake pan assembly of FIG. 1 which is embossed and fluted;

FIG. 4 is a top plan view of the cover of the rectangular cake pan of FIGS. 2 and 3;

FIG. 5 is a side elevational view of the base pan of FIG. 1;

FIG. 6 is an end elevational view of the base pan of FIG. 1;

FIG. 7 is a partial sectional side elevational view of the assembled rectangular cake pan assembly of FIG. 1;

FIG. 8 is an enlarged partial view of the slide fastener as shown in detail A of FIG. 7 with movement of the same shown in phantom;

FIG. 9 is an enlarged partial view of the base pan flange and locking end of the fastener member shown in FIG. 8;

FIG. 10 is a perspective view of the base pan shown in FIG. 3;

FIG. 11 is a top plan view of the base pan shown in FIG. 3 with the fasteners fully extended;

FIG. 12 is a side elevational view of the rectangular cake pan assembly shown in FIG. 3;

FIG. 13 is a bottom plan view of the base pan shown in FIG. 1; and

FIG. 14 is a perspective view of the rectangular cake pan assembly of FIG. 3.

### DETAILED DESCRIPTION OF THE INVENTION

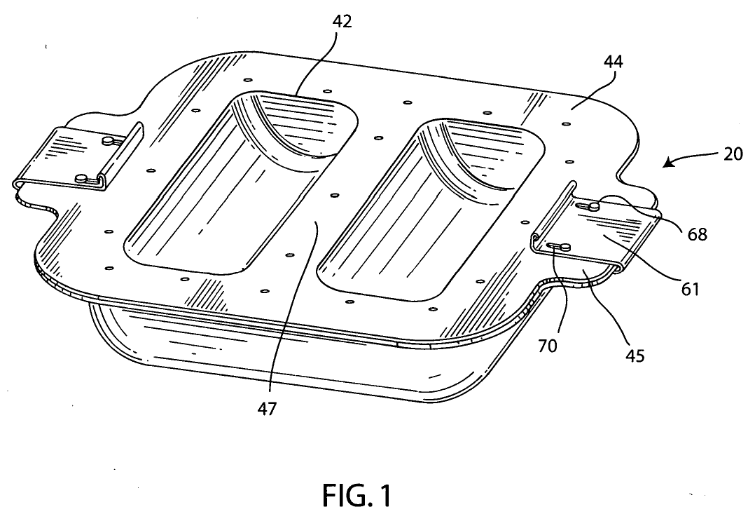

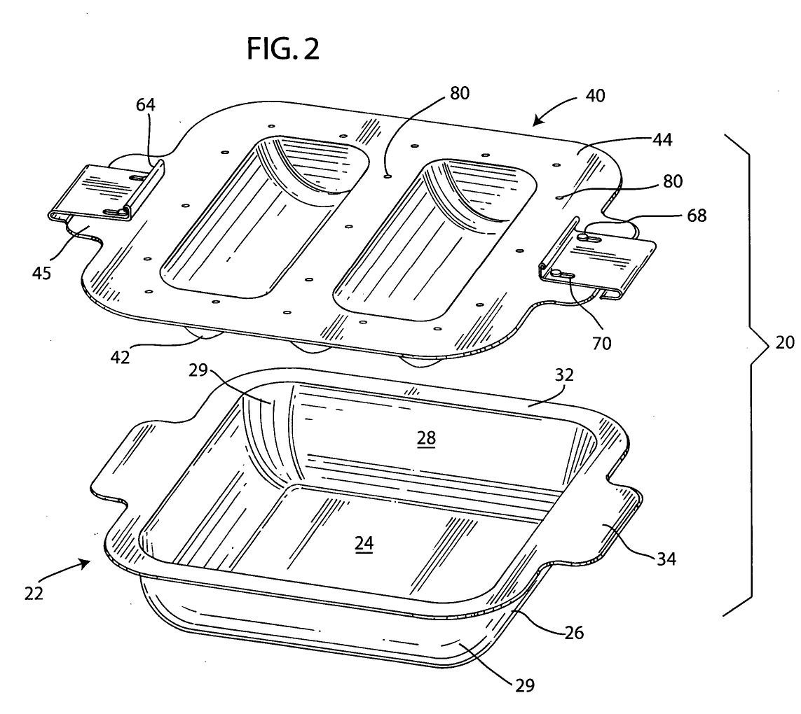

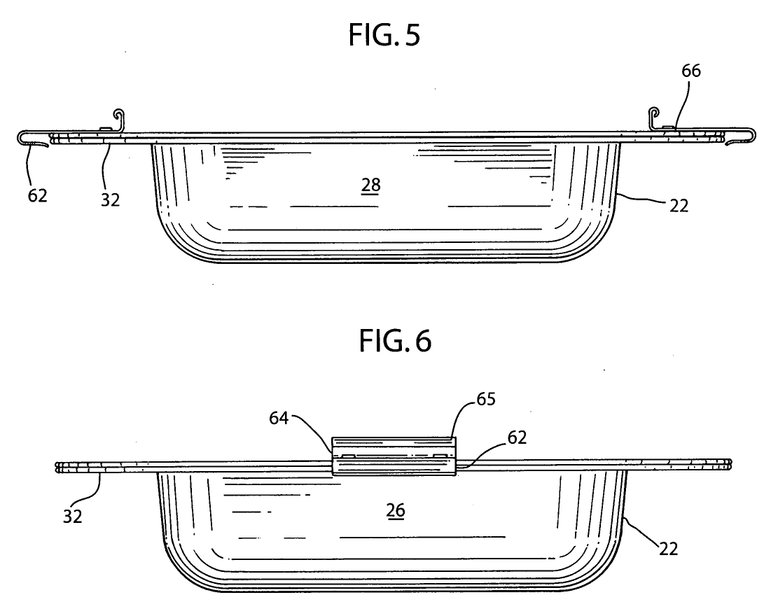

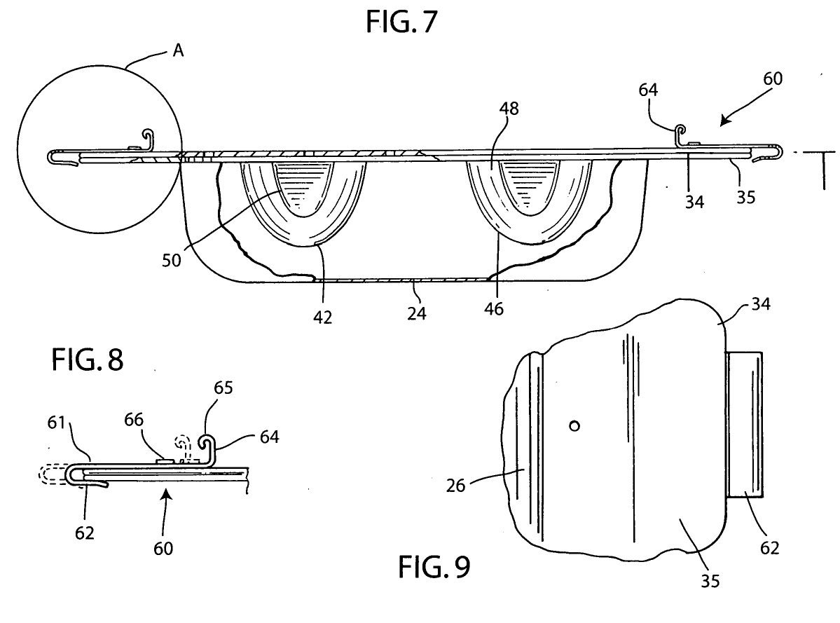

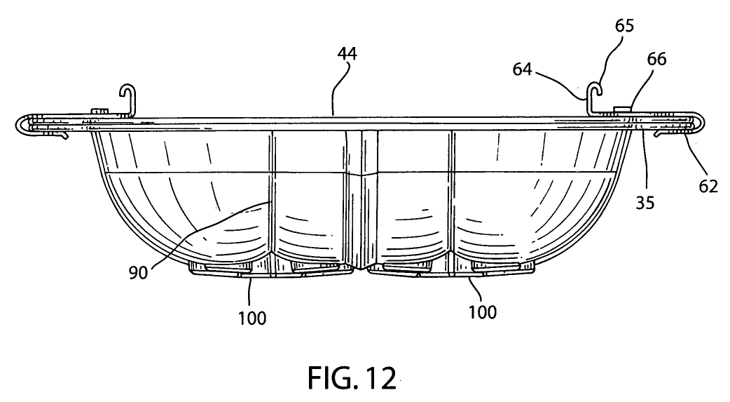

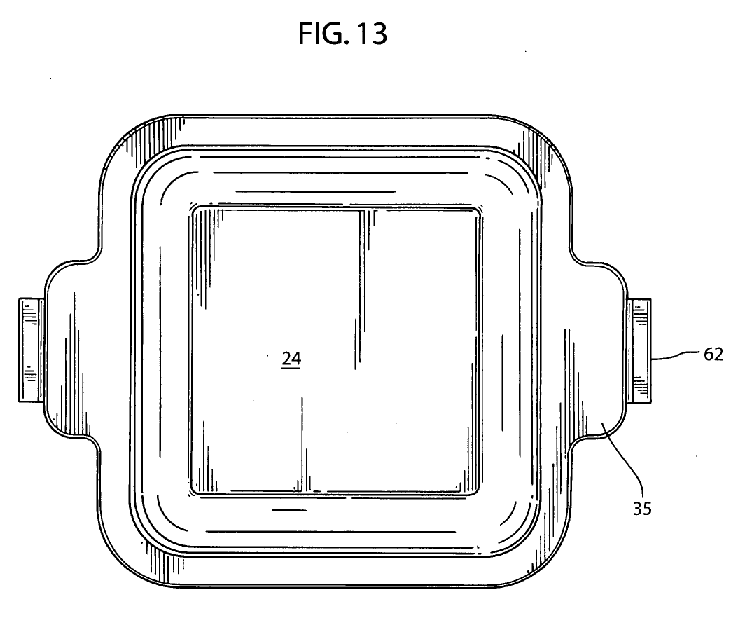

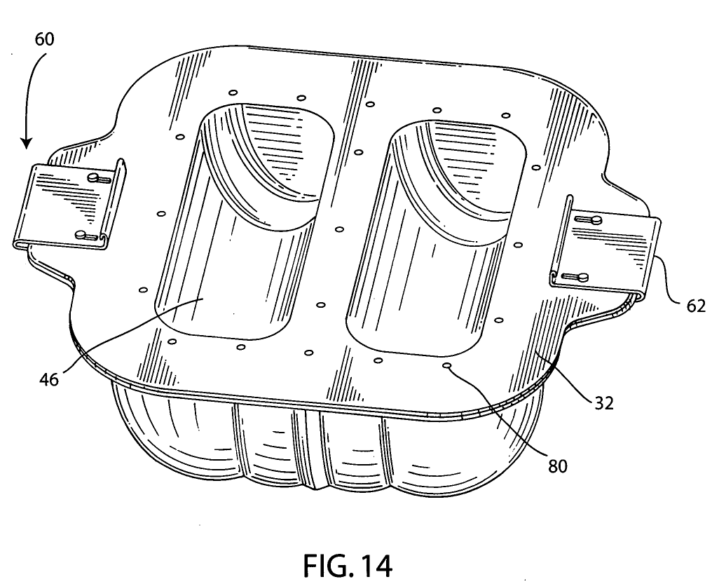

The preferred embodiment and best mode of the invention is shown in FIGS. 1 through 14. The term “batter” as used herein in the application is meant to encompass cake batter, dough, malleable ice cream, gelatin or a malleable dessert which sets up in a rigid or semi-rigid shape.

Referring to the Figures, a rectangular cake pan assembly 20 according to the invention is adapted to shape or mold batter for a composite cake or other multiple compositions of baked goods or complimentary desserts such as ice cream, gelatins, puddings into a rectangular cake shaped dessert with a fluted outer surface having a smooth oblong shaped cavity with an option base formed in a base tray.

The pan assembly 20 is constructed with rectangularly shaped base pan 22 having a bottom member24, end walls 26 and sidewalls 28 defining a cavity 30. The end walls 26 and sidewalls 28 are integrally joined at rounded corners 29 so that a continuous side wall is formed. A planar flange 32 extends outward from the upper end of the end walls 26 and sidewalls 28 with the flange protruding further away from the end walls to form handles 34.

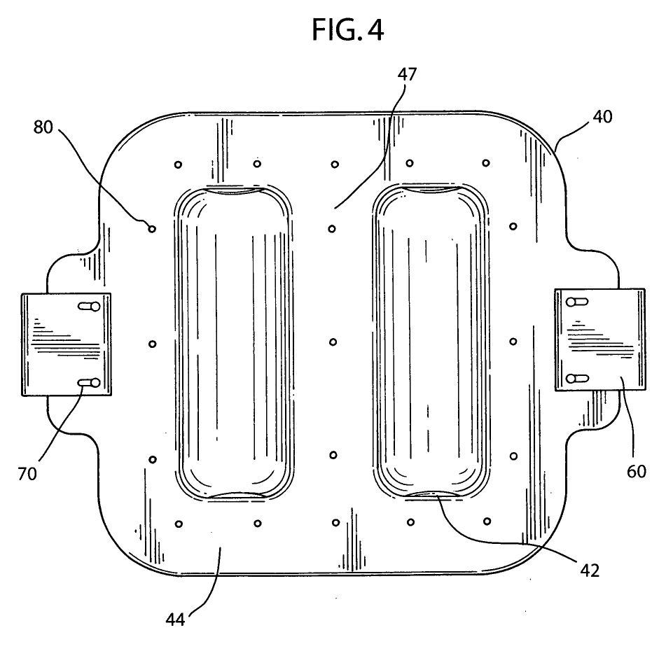

A cover member 40 is formed with a plurality of integral spaced oblong shaped projecting bowls 42 with a smooth inner and outer surface and an integral planar outwardly extending skirt portion 44 as shown in FIGS. 1, 2 and 7. Each inner bowl 42 is typically symmetrical with an oblong shape having a curved closed bottom surface 46 and an open end 48 defined by planar skirt 44 to form chamber or cavity 50. A cross section taken across the cavity 50 perpendicular to the longitudinal axis is substantially hemispherical in shape although other curved shapes can be used. Each bowl 42 extends away from the skirt 44 allowing it to be seated in chamber or cavity 30 of the rectangular base cake pan 22 with the skirt handles 45 seated on base pan handles 34. The cover member 40 is provided with slide lock member 60 on each handle 45 which is shaped to fit over the handle 34 of the rectangular cake pan. The skirt 44 covers the outer surface of the cavity 30. The sliding lock member is constructed with the lock member body 61 which is rolled or bent on each end in a shaped configuration as shown in FIGS. 1, 2 and 8 so that the distal end portion 62 is curved back from the body so that it engages the lower surface 35 of handle 34 when the slide member 60 is moved inward to lock the same in a fixed position. The motion of the slide member is shown in phantom in FIG. 8. At the other end of lock member body 61 is an integral push bar 64 that extends upward from the planar lock member body surface with the end of the push bar 64 being rolled to form a lip 65. Posts 66 are secured to the upper surface of each handle 45 and extend through slots 70 cut through the slide member body 61. Each post 66 is provided with a head 68 having a greater diameter than the width of slot 70. The push bar 64 is positioned in a reverse orientation from that of the locking end 62. The push bar 64 is upstanding from the planar surface of the skirt 44 and its end is rolled to provide a lip 65 as previously noted so that a user can readily slide the slide member 60 to lock and unlock the cover member 40 from the base pan 22. A plurality of throughgoing apertures 80 are spaced around the periphery of the cover over the pan cavity 30 and through the s47 pace between the inner bowls 42 as shown in FIGS. 1 and 4 to allow steam to escape from the cake batter during the cooking process.

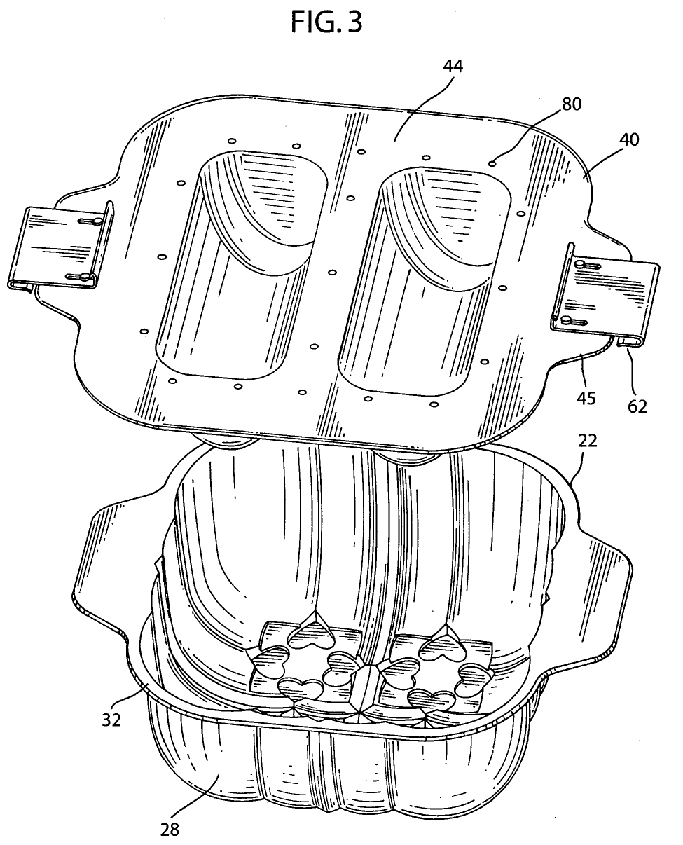

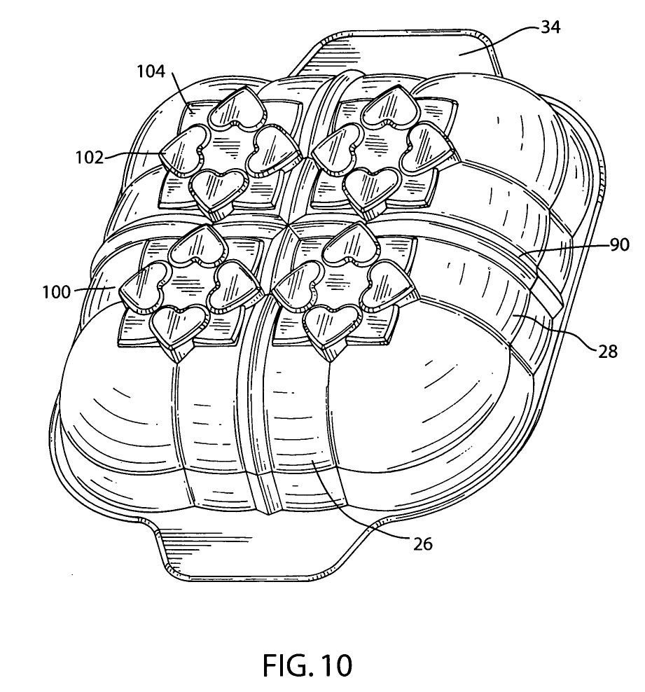

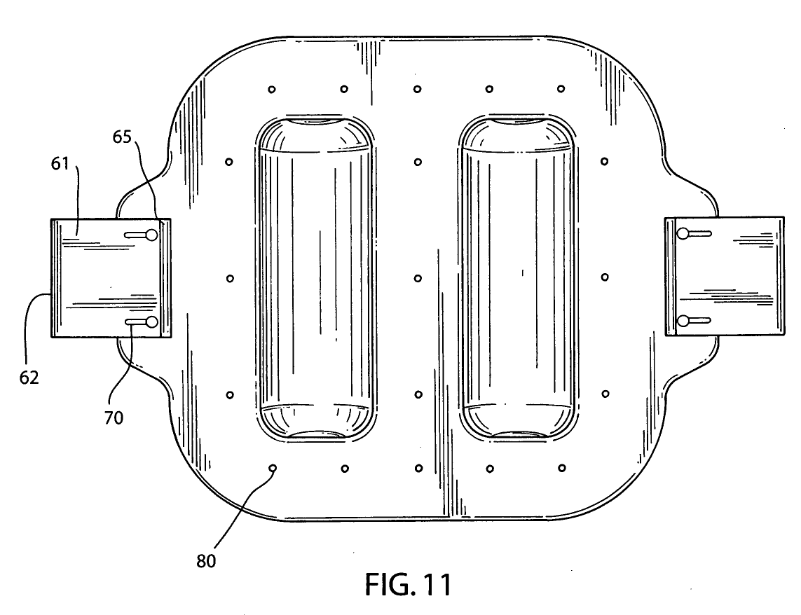

In the variation shown in FIGS. 3, 10, 12 and 14 the base pan 22 is fluted 90 and embossed with a pattern 100 which can be any suitable design. In the present embodiment, as clearly shown in FIG. 10, the design is that of hearts 102 arranged on a rectangular support 104.

The rectangular cake pan 22 and cover 40 are preferably constructed of sheet steel or stainless steel but can be constructed of copper, aluminum, cast iron, pyrex, glass, porcelain, ceramic or any type of microwaveable material at a uniform desired thickness commonly used for baking pans and containers. If desired, the rectangular cake pan body can have its external surface coated with a non-corroding material such as tin or chromium. The tray and its respective fluted sides may be constructed of a single sheet of metal formed into the desired shape. The inside and outside surface of cover member 40 and base pan 22 are preferably coated with one or more nonstick coatings, such as for example TEFLON® (i.e., fluorocarbon polymers), (e.g., tetrafluroethlene and fluorinated ethylene propylene) in the preferred embodiment to ease the removal of the baked or chilled product from the bowl. It will be appreciated by those skilled in the art that other shapes and geometries of pan assemblies are possible, and that the specifics of material of which it is made can be changed without departing from scope of the invention. The rectangular base pan 22 and cover member 40 can be stamped from a solid piece of material or spun from aluminum instead of formed from a sheet.

As previously noted, the interior surface and outside surface of the each configuration which contacts the batter or dessert composition is covered with TEFLON® in the preferred embodiment to ease the removal of the baked or chilled product from the bowl. The sloping of the inner wall of the rectangular cake pan cavity 30 and cover member oblong bowl 42 and cavity 50 further eases removal of the final dessert composition. It will be appreciated by those skilled in the art that other shapes and geometries of pan assemblies are possible, and that the specifics of material of which it is made can be changed without departing from scope of the invention.

In operation, cake batter is poured into the rectangular base pan cavity 30 about ⅔ to ¾ full. A second cake batter of a different flavor as for example chocolate is poured in the cavities 50 of the bowls 42 of the cover about ⅔ to ¾ of the depth of each bowl.

After the batter is molded and baked by the application of heat, the rectangular cake pan assembly is removed from the oven. The TEFLON® coating of the interior and exterior surface of the rectangular cake pan facilitates removal of the mold without tearing or damaging the final baked product located in cavity. The smaller baked interior cakes are then removed from chamber or cavity 50 of the cover. The interior cakes or other optional filling taken from cavities 50 are then placed in the respective cavities formed in the base of the cake by the cover and the composite assembly is inverted onto a serving area for frosting, icing or other decoration preparatory to being served. The result is a dual composition cake or dessert which is rectangular cake shaped or fluted and ready to eat. The multiple cavities in the cake may be filled or coated with ice cream, pudding, icing or other sweet filling for a dessert pastry.

Although aluminum, sheet steel and/or stainless steel is preferred for the outer bowl body, any suitable structural material, as previously identified, could be used in its place. The inner bowl body has the same material as that of the outer body.

The principles, preferred embodiments and modes of operation of the present invention have been described in the foregoing specification. However; the invention should not be construed as limited to the particular embodiments which have been described above. Instead, the embodiments described here should be regarded as illustrative rather than restrictive. Variations and changes may be made by others without departing from the scope of the present inventions defined by the following claims.

1. A dessert pan assembly for forming a dessert in a predetermined shape comprising:
a substantially rectangular base pan comprising a plurality of walls and a bottom defining an open cavity, a planar flange extending outward from said walls, said flange defining handles and a cover member mounted on said flange, said cover member comprising an outer planar skirt and a plurality of spaced rounded projections extending away from a plane of said planar skirt to extend into said substantially rectangular base pan cavity, each of said rounded projections defining an open ended cavity, said outer planar skirt being seated on said substantially rectangular base pan flange and extending over said base pan cavity and slideable locking means mounted on handles formed by said cover member adapted to selectively engage said base pan handles holding said cover member on said substantially rectangular cake pan.

2. A dessert pan assembly as claimed in claim 1 wherein said substantially rectangular base pan is substantially rectangular in configuration with rounded corners and smooth surfaced end walls and smooth surfaced side walls.

3. A dessert pan assembly as claimed in claim 1 wherein said substantially rectangular base pan is substantially rectangular in configuration with rounded corners with fluted walls and embossed decorations formed in said walls.

4. A dessert pan assembly as claimed in claim 1 wherein said plurality of spaced rounded projections have an oblong rounded configuration with a smooth surface.

5. A dessert pan assembly as claimed in claim 1 wherein at least one surface of said substantially rectangular base pan and at least one surface of said cover member are coated with a nonstick material.

6. A dessert pan assembly as claimed in claim 5 wherein said nonstick material is tetrafluroethlene.

7. A dessert pan assembly as claimed in claim 5 wherein said nonstick material is fluorinated ethylene propylene.

8. A dessert pan assembly as claimed in claim 1 wherein said slideable locking means comprises a planar base section defining a plurality of throughgoing parallel slots, post means mounted to said cover member extending through said throughgoing slots, said base section being formed with an inwardly curved distal end section which can engage said base pan flange handles.

9. A dessert pan assembly as claimed in claim 8 wherein said base section has an upwardly turned proximal end portion with a rounded strip.

10. A dessert pan assembly as claimed in claim 1 wherein said cover member skirt defines a plurality of throughgoing holes.

11. A dessert pan assembly as claimed in claim 10 wherein said holes surround each projection cavity.

12. A dessert pan assembly for forming a dessert in a predetermined shape comprising:
a rectangular base pan comprising a plurality of walls and a bottom having a curved intersection defining an open cavity and a planar flange extending outward from said walls, said flange forming handles, a cover member mounted on said planar flange, said cover member comprising an outer planar skirt and a plurality of spaced projection members having a curved outer surface defining a plurality of open ended curved cavities and extending away from a plane of said planar skirt to extend into said rectangular base pan cavity, said outer planar skirt being seated on said rectangular base pan flange and extending over said rectangular cake pan cavity and a slideable reciprocating locking member mounted on a handle formed by said cover member skirt, said slideable locking member being adapted to selectively engage said rectangular base pan handles holding said cover member on said rectangular cake pan.

13. A dessert pan assembly as claimed in claim 12 wherein said rectangular base pan and said cover member are coated with non-stick material.

14. A dessert pan assembly as claimed in claim 12 wherein said slideable locking means comprises a planar base section defining a plurality of spaced throughgoing slots and a distal end portion bent back towards said base plan handle, said slideable locking means being mounted on said cover member handles, post means mounted to said cover member handles extending through said throughgoing slots allowing said planar base section to reciprocated toward and away from said walls of said base pan.

15. A dessert pan assembly as claimed in claim 12 wherein said skirt defines a plurality of throughgoing holes located around each of the spaced rounded projection cavities.

16. A dessert pan assembly as claimed in claim 12 wherein said base pan has a surface which is embossed to leave an imprint of an embossed design in desserts formed in said base pan.

17. A dessert pan assembly for forming a dessert in a predetermined shape comprising:
a rectangular base pan comprising a plurality of walls and a bottom defining an open cavity and a planar flange extending outward from said walls, said flange forming handles and a cover member mounted on said flange, said cover member comprising a planar skirt and a plurality of spaced rounded projections defining a plurality of open ended cavities extending away from a plane of said planar skirt to extend into said rectangular base pan cavity, said planar skirt further defining a plurality of throughgoing holes surrounding said projections open end, said outer planar skirt being seated on said rectangular base pan flange and extending over said rectangular cake pan cavity and slideable locking means mounted on handles formed by said cover member adapted to selectively engage said rectangular base pan handles holding said cover member on said rectangular cake pan, said slideable locking means comprises a planar base section defining two throughgoing parallel slot, post means mounted to said cover member extending through said throughgoing slots, said base section being formed with an inwardly curved distal end section which can engage said base pan flange handles and a proximal end section which extends away from the planar surface of said cover member.

18. A dessert pan assembly as claimed in claim 17 wherein said plurality of spaced rounded projections have an oblong rounded configuration with a smooth surface.

19. A dessert pan assembly as claimed in claim 17 wherein said base pan has a surface which is embossed to leave an imprint of an embossed design in desserts formed in said base pan.

20. A dessert pan assembly as claimed in claim 17 wherein said substantially rectangular base pan is substantially rectangular in configuration with rounded corners and smooth surfaced end walls and smooth surfaced side walls.
